(19) United States
(12) Patent Application Publication
(10) Pub. No.: US 2011/0085122 A1
(43) Pub. Date: Apr. 14, 2011

(54) ACTIVE DEVICE ARRAY SUBSTRATE AND DISPLAY DEVICE

(76) Inventors: Chien-Hao Fu, Taipei County (TW); Wei-Kai Huang, Tainan City (TW); Chia-Chiang Lin, Changhua County (TW); Hsueh-Hui Lin, Pingtung County (TW); Ming-Chin Lee, Taipei County (TW)

(21) Appl. No.: 12/753,091

(22) Filed: Apr. 1, 2010

(30) Foreign Application Priority Data
Oct. 13, 2009 (TW) 98134645

(51) Int. Cl. G02F 1/1345; G09G 3/20

(52) U.S. Cl. 349/149; 345/55

(57) ABSTRACT

An active device array substrate including a substrate, scan lines, control lines, data lines, pixel structures, main transmission lines and sub transmission lines is provided. The substrate has an active area and a peripheral area. The scan lines and the control lines are disposed within the active area. The control lines are parallel to the scan lines and each control line is located between two of the scan lines. The main transmission lines located within the peripheral area are connected with the scan lines. The sub transmission lines located within the peripheral area are connected with the control lines. Each sub transmission line is located between two of the main transmission lines. Each main transmission line at least includes an impedance adjusting unit, and the impedance difference between each main transmission line and one of the adjacent sub transmission lines is larger than 3Ω.

### CROSS-REFERENCE TO RELATED APPLICATION

This application claims the priority benefit of Taiwan application serial no. 98134645, filed on Oct. 13, 2009. The entirety of the above-mentioned patent application is hereby incorporated by reference herein and made a part of specification.

### BACKGROUND OF THE INVENTION

1. Technical Field

The invention relates to an active device array substrate and a display device. More particularly, the invention relates to an active device array substrate and a display device having uniform impedance and favorable display quality.

2. Description of Related Art

Generally speaking, a flat panel display device includes an active device array substrate, a color filter substrate and a back light module. When the demands by the general public on the display quality and function continue to increase, the design of conductive lines, i.e. the circuit layout on an active device array substrate becomes more complicated.

FIG. 1 is a diagram showing a local top view and an enlarged view of an active device array substrate in the related art. As shown in FIG. 1, the active device array substrate 100 includes a substrate 101, a plurality of scan lines 111, a plurality of data lines 121, a plurality of pixel structures 108 and a plurality of transmission lines 130. The substrate 101 includes an active region 102 and a peripheral region 104. The plurality of scan lines 111 is disposed in the active region 102 of the substrate 101, and the plurality of data lines 121 intersects with the plurality of scan lines 111. The plurality of pixel structures 108 is disposed in the active region 102 of the substrate 101.

The plurality of transmission lines 130 is disposed in the peripheral region 104 of the substrate 101 and is electrically connected to the scan lines 111. The peripheral region 104 further includes a plurality of signal pads 136, wherein the scan lines 111 are electrically connected with the driver IC 140, through the transmission lines 130 and the signal pads 136, for receiving the corresponding scan signals. The part where the scan lines 111 and the signal pads 136 are electrically connected via the transmission lines 130 is known as the fan-out area 106. To obviate any adverse effect on the quality of signal transmssion due to the impedance difference between the transmission lines 130, the transmission lines 130 in the fan-out area 106 are routed to adjust the transmission impedance correspondingly.

Due to the demands on high image quality, the design on pixel structures becomes progressively complicated. Further, due to the demands on multi-function products, elements, such as the touch sensing device, the photosensitive device control device, etc., are integrated in the active device array substrate 100. The number of pins of the driver IC 140 and the number of the transmission lines 130 increases accordingly. Hence, the space that could be afforded for the routing of the transmission lines is limited and the transmission impedance difference of the transmission lines 130 can not be effectively adjusted and tuned.

### SUMMARY OF THE INVENTION

In view of the foregoing, the invention provides an active device array substrate, wherein the circuit of the control display pixel provides a consistent display quality.

The invention further provides a display device having the above active device array substrate, and the display device has a desirable display quality.

According to an exemplary embodiment of the invention, an active device array substrate is provided, and the active device array substrate includes a substrate, a plurality of scan lines, a plurality of control lines, a plurality of data lines, a plurality of pixel structures, a plurality of main transmission lines and a plurality of sub transmission lines. The substrate includes an active region and a peripheral region, wherein the peripheral region is positioned at a periphery of the active region. The plurality of scan lines is disposed in the active region of the substrate. The plurality of control lines is disposed in the active region of the substrate and parallel to the plurality of scan lines, wherein “m” control lines are disposed next every “n” scan lines, and “n” and “m” are positive integers. The plurality of data lines intersects with the plurality of scan lines and the plurality of the control lines. The plurality of pixel structures is disposed in the active region of the substrate, wherein a display voltage transmitted by the plurality of data lines is controlled by a scan voltage of the plurality of scan lines and is inputted to the plurality of pixel structures. The plurality of main transmission lines is positioned in the peripheral region of the substrate and connected with the plurality of scan lines. The plurality of sub transmission lines is positioned in the peripheral region of the substrate and connected with the plurality of control lines, wherein the plurality of sub transmission lines and the plurality of main transmission lines are configured alternately. Each of the plurality of main transmission lines includes at least an impedance adjusting unit, and an impedance difference between at least one of the plurality of main transmission lines and one of adjacent sub transmission lines is greater than 3 ohms (Ω).

According to an exemplary embodiment of the invention, each of the above-mentioned pixel structures includes a first active device, a second active device, a first pixel electrode, and second pixel electrode and a control switch. The first active device is electrically connected with one of the scan lines and one of the data lines. The second active device is electrically connected with one of the scan lines and one of the data lines. The first pixel electrode is electrically connected with the first active device. The second pixel electrode is electrically connected with the second active device. The control switch is electrically connected with the second pixel electrode, and one of the control lines are electrically connected with the control switch.

According to an exemplary embodiment of the invention, the above-mentioned active device array substrate further includes a plurality of signal pads, configured in the peripheral region of the substrate. The plurality of main transmission lines connects between the plurality of scan lines and the corresponding plurality of signal pads, while the plurality of sub transmission lines connects between the plurality of control lines and the corresponding plurality of signal pads.

According an exemplary embodiment of the invention, the above-mentioned “m” sub transmission lines are disposed next every “n” main transmission lines, and “n” and “m” are positive integer.

According to an exemplary embodiment of the invention, the above-mentioned active device array substrate further includes a plurality of touch sensing devices disposed in the active region, and the plurality of control lines is electrically connected with the plurality the touch sensing devices and the corresponding plurality of sub transmission lines.

According to an exemplary embodiment of the invention, the above at least one impedance adjusting unit includes at least one circuitous line. The circuitous line includes a plurality of first line segments and a plurality of second line segments, wherein the first line segments extend along a first direction, and the second line segments extend along a second direction, and the first line segments and the second line segments are connected end-to-end. The lengths of the first line segments are different from the lengths of the second line segments. The first direction is parallel to an extension direction of the plurality of main transmission lines, and the second direction is perpendicular to the extension direction of the plurality of main transmission lines.

According to an exemplary embodiment of the invention, the above at least impedance adjusting unit comprises a multi-layer wiring, and the multi-layer wiring comprises multi layers of conductive lines that are stacked and connected in parallel.

According to an exemplary embodiment, a line width of the at least one impedance adjusting unit of one of the plurality of main transmission lines is different from the line width of the at least one impedance adjusting unit of another one of the plurality of main transmission lines. The line widths of the plurality of sub transmission lines are constant values, while the line widths of the plurality of main transmission lines range from 5 μm to 40 μm.

The invention also provides a display apparatus that includes a first substrate and a second substrate. The first substrate is the above-mentioned active device array substrate, while the second substrate is disposed opposite to the first substrate.

According to an exemplary embodiment of the invention, the above display device is a touch sensing display panel, a liquid crystal display panel, a flexible display panel, an organic light emitting display or an electrophoresis display panel.

In according to the active display array substrate of the invention, only the impedances of the main transmission lines are adjusted, while the impedance of the sub transmission lines are not adjusted. Hence, the main transmission lines of the invention are provided with more space for impedance adjustment, and the signal lines controlling the display pixel structures demonstrate uniform signal transmission quality. Since the display device of the invention includes the above active device array substrate, the charging time of each pixel structure is substantially the same, and a desirable display quality is achieved.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a diagram showing a localized top view and an enlarged view of an active device array substrate of related art.

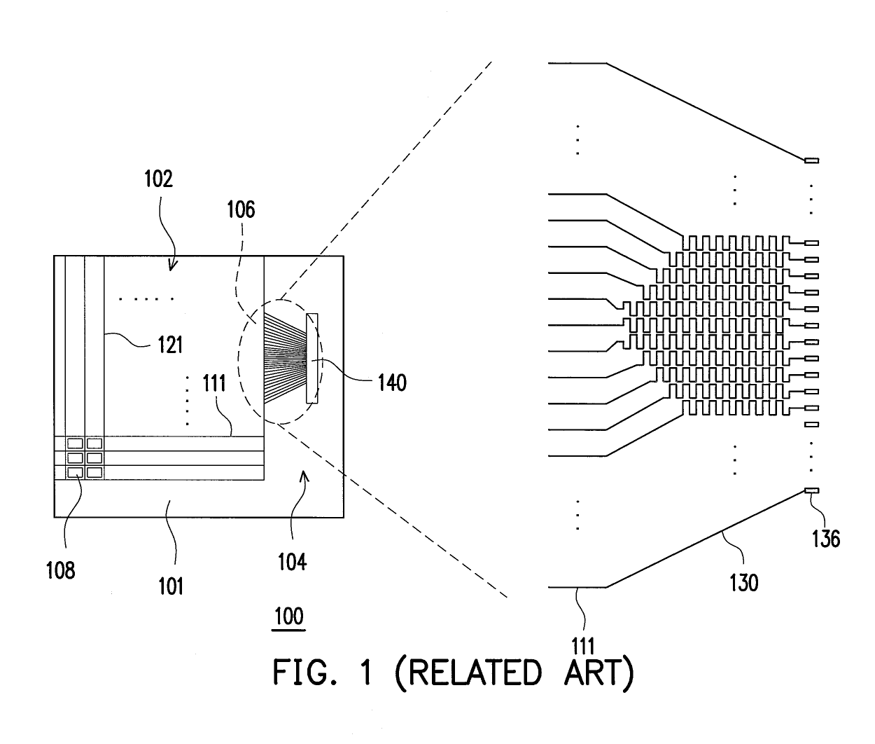

FIG. 2 is a partial top view diagram of an active device array substrate according to an embodiment of the invention.

FIG. 3 is a circuit diagram of the pixel structure in FIG. 2.

FIG. 4 is a schematic diagram of the fan-out area 206 in FIG. 2 and a partial enlarged view of the fan-out area 206.

FIG. 5 is a schematic diagram of another fan-out area of the invention.

FIG. 6 is a schematic diagram of another fan-out area of the invention.

FIG. 7 is a schematic diagram of another fan-out area of the invention.

FIG. 8 is a schematic, cross-sectional diagram of FIG. 7 along the a-a′ line.

FIG. 9 is another circuit diagram of the pixel structure in FIG. 2.

FIGS. 10(a) to (d) are diagrams showing the circuit layouts of the main transmission lines and the sub transmission lines according to one exemplary embodiment of the invention.

FIG. 11 is a schematic diagram of a display device according to an exemplary embodiment of the invention.

### DESCRIPTION OF THE PREFERRED EMBODIMENTS

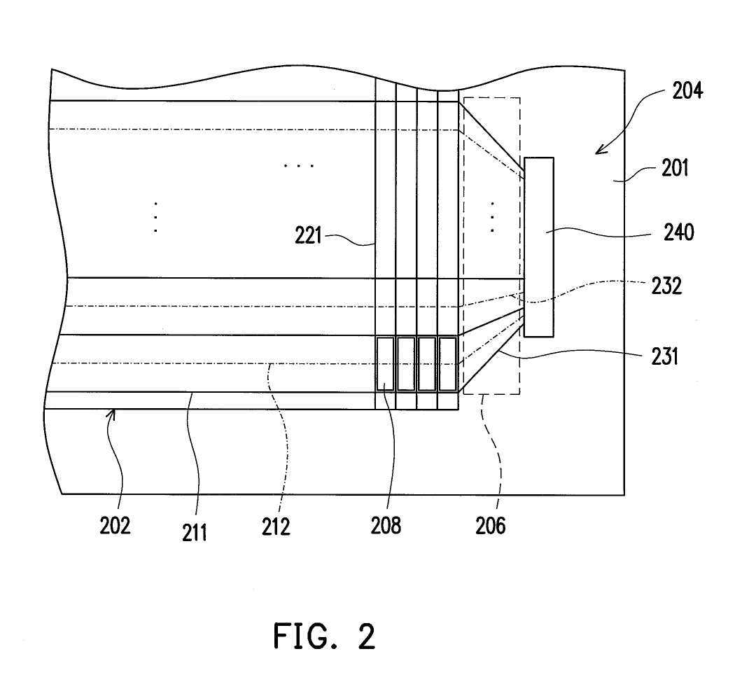

FIG. 2 is a partial top view diagram of an active device array substrate according to an embodiment of the invention. Referring to FIG. 2, the active device array substrate 200 includes a substrate 201, a plurality of scan lines 211, a plurality of control lines 212, a plurality of data lines 221, a plurality of pixel structures 208, a plurality of main transmission lines 231 and a plurality of sub transmission lines 232. The substrate 201 includes an active region 202 and a peripheral region 204, wherein the peripheral region 204 is configured at the periphery of the active region 202. The plurality of control lines 212 is disposed in the active region 202 of the substrate 201, parallel to the scan lines 211, wherein each scan line 211 is disposed next one control line 212. Simply speaking, the plurality control lines 212 and the plurality of scan lines 211 are disposed alternately.

The plurality of data lines 221 intersects with the plurality of scan lines 211 and the plurality of control lines 212. The plurality of pixel structures 208 is disposed in the active region 202 of the substrate 201, and the display voltages transmitted by the plurality of data lines 221 are controlled by the scan voltages of the plurality of scan lines 211 and are inputted to the plurality of pixel structures 208.

Moreover, the active device array substrate 200 further includes a driver IC 240, configured at the peripheral region 204, and the fan-out area 206 is configured between the display region 202 and the driver IC 240.

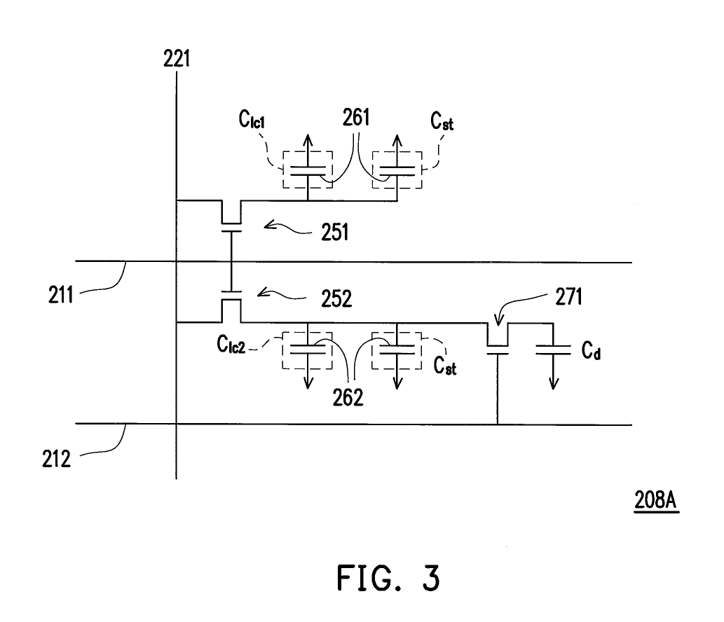

More specifically, FIG. 3 is a circuit diagram of the pixel structure in FIG. 2. Referring to FIG. 3, the pixel structure 208A includes a first active device 251, a second active device 252, a first pixel electrode 261, a second pixel electrode 262 and a control switch 271. The first active device 251 and the second active device 252 are electrically connected with one of the scan lines 211 and one of the data lines 221. The first pixel electrode 261 is electrically connected with the first active device 251, while the second pixel electrode 262 is electrically connected with the second active device 252.

The scan voltage of the scan line 211 turns on the first active device 251 and the second active device 252, and the display voltage required by the first pixel electrode 261 and the second pixel electrode 262 is transmitted to the first pixel electrode 261 and the second pixel electrode 262 through the data line 221. To stabilize the liquid crystal capacitor C_{1c1} and the liquid crystal capacitor C_{1c2} for maintaining a desirable display quality, each of the liquid crystal capacitors C_{1c1} and C_{1c2} is electrically connected with the corresponding storage capacitors Cₛₜ of the first pixel electrode 261 and the second pixel electrode 262 The storage capacitors Cₛₜ of first pixel electrode 261 and the second pixel electrode 262 are, for example, capacitors having the same storage capacitance or capacitors having different storage capacitances. The invention is not particularly limited to one or the other.

Additionally, to further enhance the display quality, the second pixel electrode 262 is electrically connected to the control switch 271. Another end of the control switch 271 is electrically connected to an auxiliary capacitor C_{d}. More specifically, the control switches 271 is turned-on and off through the control lines 212 in order for the auxiliary capacitor C_{d} and the second pixel electrode 262 to be electrically connected. With the above configuration, the sums of the capacitors that are electrically connected to the first and the second pixel electrodes 261, 262, respectively, are different; and accordingly, the pixel structure 208A has two regions with different display gray levels. This type of design aids mitigating the problem of color washout.

Nevertheless, the charging times of the first active device 251 and the second active device 252 affect the display quality of the pixel structure 208A. Accordingly, the signal transmission quality of all the scan lines 211 in the active device array substrate 200 can not be deviated to a large degree. In contrast, the charging time of the control switch 271 does not directly affect the display quality of the pixel structure 208A. Hence, the signal transmission quality of the control lines 212 can, afford a larger difference. Accordingly, several methods of circuit layout for altering the impedance of each conductive line in order to correspondingly adjust the transmission quality of each conductive line are described hereinafter.

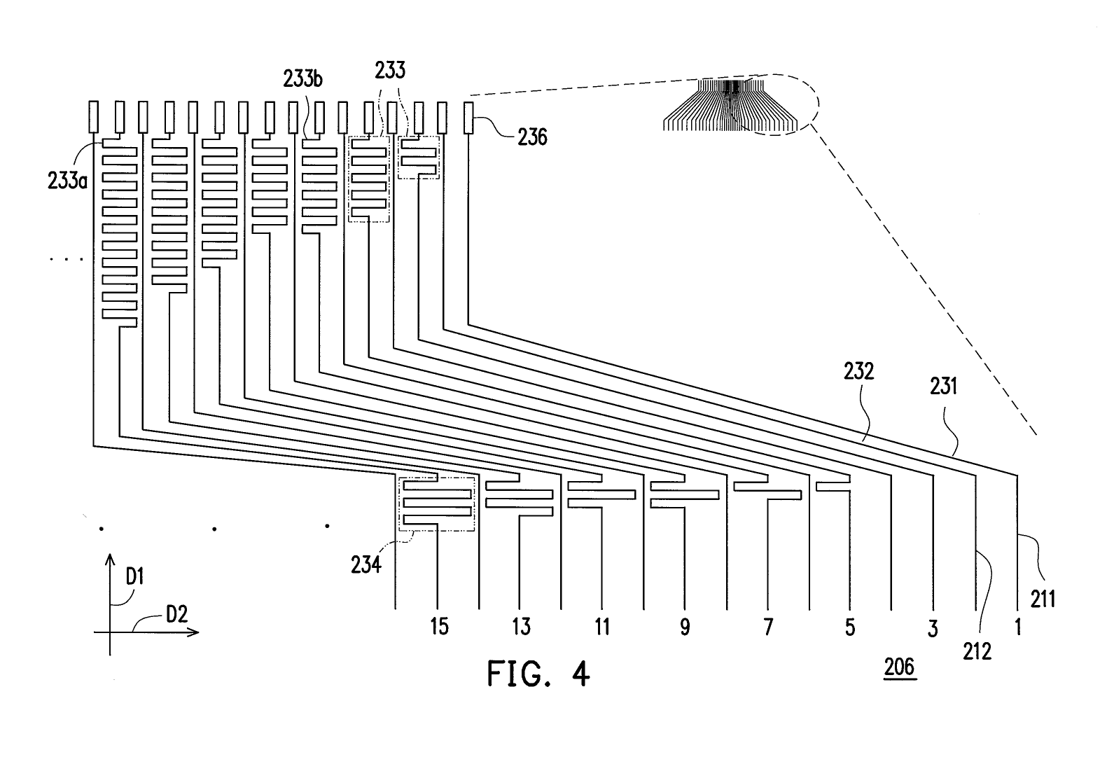

FIG. 4 is a schematic diagram of the fan-out area 206 in FIG. 2 and a partial enlarged view of the fan-out area 206. Referring to both FIGS. 2 and 4, a plurality of main transmission lines 231 is configured in the peripheral region 204 of the substrate 201, and the plurality of main transmission lines 231 is electrically connected with the plurality of scan lines 211. A plurality of sub transmission lines 232 is configured in the peripheral region 204 of the substrate 201 and is electrically connected with the plurality of control lines 212, wherein the plurality of sub transmission lines 232 and the plurality of the main transmission lines 231 are alternately configured. Moreover, the active device array substrate 200 further includes a plurality of signal pads 236, configured in the peripheral region 204 of the substrate 201. The plurality of main transmission lines 231 connects the plurality of scan lines 211 with the corresponding plurality of signal pads 236. Further, the plurality of sub transmission lines 232 connects between plurality of control lines 212 and the corresponding plurality of signal pads 236. Hence, each conductive line is connected to the corresponding driver IC 240.

More specifically speaking, in the fan-out area region 206, the odd number conductive lines (1, 3, 5 . . . ) are the main transmission lines 231 electrically connected to the scan lines 211, while the even number conductive lines (not referenced) are the sub transmission lines 232 electrically connected to the control lines 212. It should be appreciated that, in other aspects of the invention, the sub transmission lines 232 and the main transmission lines 231 may be configured alternately. In other words, the main transmission lines 231 and the sub transmission lines are arranged repeatedly in a regular or an irregular manner. For example, any one of the odd number conductive lines (1, 3, 5 . . . ) could be the main transmission lines 231 or the sub transmission lines 232, and any one of the even number conductive lines (not referenced) could be the main transmission lines 231 or the sub transmission lines 232. Further, each main transmission line 231 includes at least one impedance adjusting unit 233.

As shown in FIG. 4, the impedance adjusting unit 233 includes at least a circuitous line, and this circuitous line includes a plurality of first line segments 233a and a plurality of second line segments 233b. The first line segments 233a extend along a first direction D1, and the second line segments 233b extend along a second direction D2, and the first line segments 233a and the second line segments 233b are connected end-to-end. The first direction D1 is, for example, parallel to the extension direction of each main transmission line 231, and the second direction D2 is, for example, perpendicular to the extension direction of each main transmission line 231. Moreover, the first line segments 233a and the second segments 233b have different lengths; in one aspect of the invention, the first circuit segments 233a are shorter than the second circuit segments 233b.

Further, each main transmission line 231 further includes another impedance adjusting unit 234, proximal to the connecting point between the scan line 211 and the main transmission line 231. The impedance adjusting unit 234 includes at least a circuitous line. The impedance adjusting unit 234 is configured in a fashion similar to that of the impedance adjusting unit 233, and the detailed description thereof could be referred to the disclosure of impedance adjusting unit 223 above. It is important to note that the positions and the arrangements of the impedance adjusting units 233, 234 should not be construed as limited to the embodiments set forth herein. In fact, the exemplary embodiment illustrated in FIG. 4 represents one aspect of the invention and this invention may be embodied in many different forms.

In this exemplary embodiment, because the main transmission lines 231 that configured at the most outer part of the fan-out area are the longest in length, they have the largest impedance. Hence, these main transmission lines 231 do not require the application of the circuitous line to increase their impedances. However, it should be appreciated that in other aspects of the invention, as recognized by one skilled in art, impedance adjustment could be applied to the main transmission lines 231 configured at the most outer part of the fan-out area, depending on the actual requirements and demands.

In this exemplary embodiment, since the impedances of the main transmission lines 231 are adjusted through the impedance adjusting units 233 and the impedances of the sub transmission lines are not adjusted, a large impedance difference between the main transmission line 231 and the adjacent sub transmission line 232 is resulted. The impedance difference between at least one main transmission line 231 and one of the adjacent sub transmission lines 232 is greater than 3 ohms (Ω). In other aspects of the invention, the impedance difference between at least one main transmission line 231 and one of the adjacent sub transmission lines 232 is at least greater than, for example 600 ohms (Ω). However, because of the impedance adjusting units 233, the impedance difference between the two adjacent main transmission lines 231 could be less than 3 ohms (Ω).

For an active device array substrate 200, the differences of the signal transmission quality among all the transmission lines 211 should not be significant. In this exemplary embodiment, only the impedances of the main transmission lines 232 are adjusted. More specifically, since the impedances of the sub transmission lines 232 are not adjusted, the line widths of the sub transmission lines 232 are controlled only to the extent that these lines are precluded from breaking. Hence, the space in the fan-out area 206 occupied by sub transmission lines 232 is not extensive. In other words, more space is available for the disposition of the impedance adjusting units 233 of the main transmission lines 231. Consequently, the transmission quality of the scan lines 211 is more uniform. Therefore, the charging time of each pixel structure 208 is more consistent.

Moreover, the overall lengths and the degree of circuitousness of the impedance adjusting units 233, 234 can be modified according to the distance between each scan line 211 and each signal pad 236. Further, a shorter the distance between the scan line 211 and the signal pad 236 is, a longer the overall lengths of the impedance adjusting units 233, 234 or a larger degree of circuitousness of the circuitous line is required. Accordingly, the transmission qualities of the different transmission lines are more comparable.

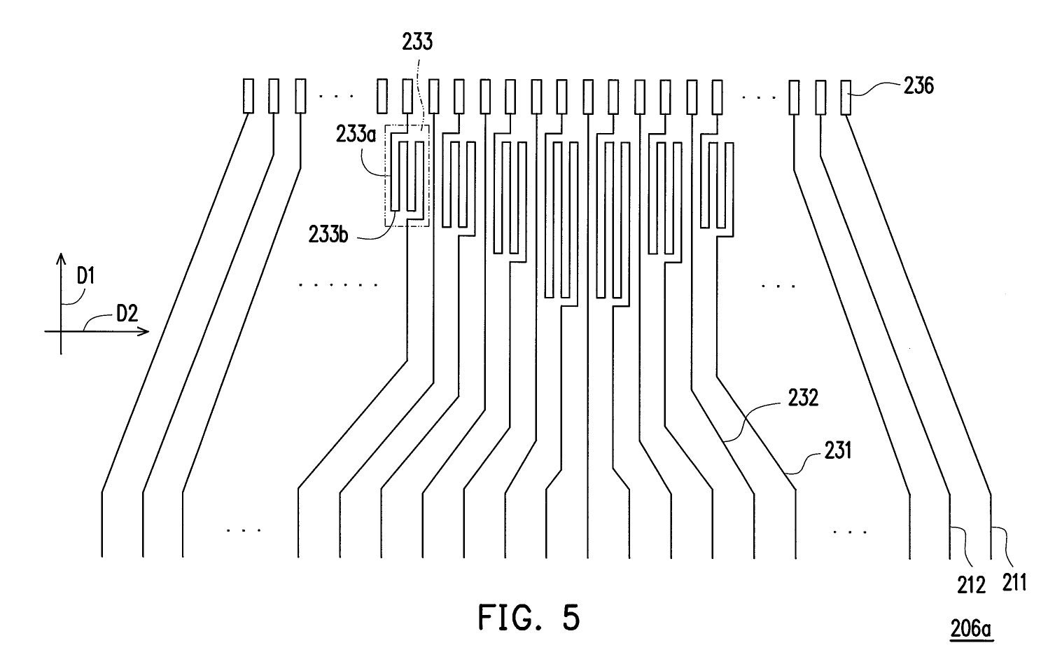

FIG. 5 is a schematic diagram of another fan-out area of the invention. Referring to FIG. 5, the above active device array substrate 200 may employ the circuit layout of the fan-out area 206a for adjusting the impedance. The difference between fan-out area 206a and the fan-out area 206 lies in the impedance adjusting units 233 in the fan-out area 206a, wherein the first line segments 233a are longer in length than the second line segments 233b. It should be appreciated that, in other aspects of the invention, the first line segments 233a and the second line segments 233b may have substantially the same length. In other words, the circuitous line of the invention is not limited to a particular coiling direction or arrangement.

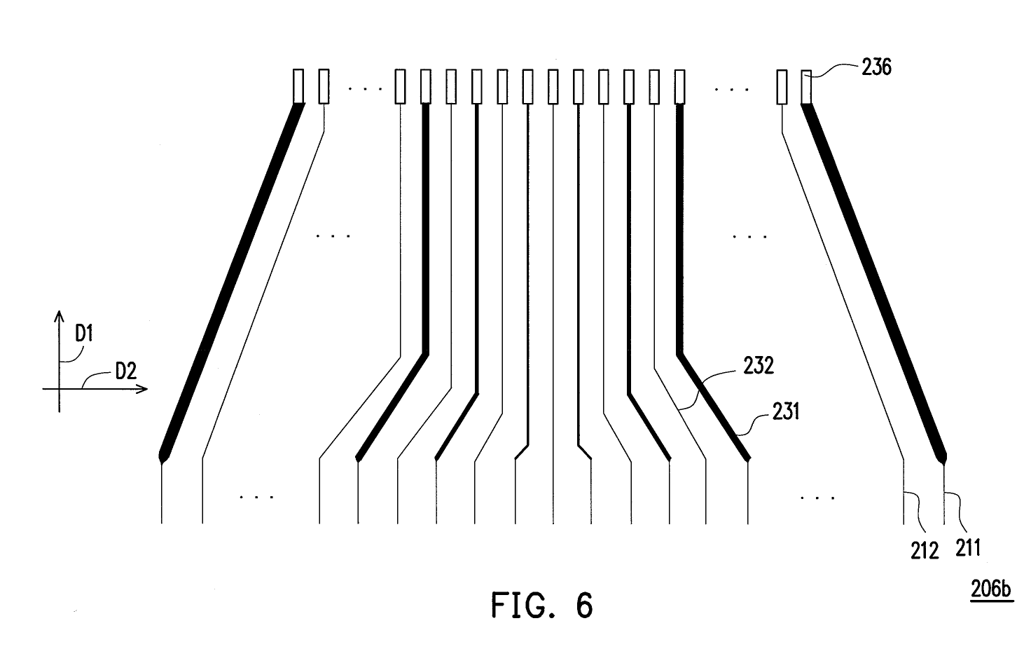

FIG. 6 is a schematic diagram of another fan-out area of the invention. Referring to FIG. 6, the difference between the fan-out area 206b and the fan-out area 206 lies in the impedance adjusting units 233 of the fan-out area 206b having different line widths. Moreover, the main transmission lines 231 are formed solely by the impedance adjusting units 233. In other words, the line widths of the plurality of main transmission lines 231 could be different.

More specifically, the line widths of the plurality of transmission lines 231 gradually reduce from the periphery to the center of the fan-out area 206b, and the line width of each sub transmission line 232 is constant. Accordingly, the differences in impedance among the different main transmission lines 231 can be effectively reduced, and the signal transmission quality of the scan lines 211 approaches uniform. In other aspects of the invention, the line widths of the main transmission lines 231 are, for example, between 5 μm to 40 μm.

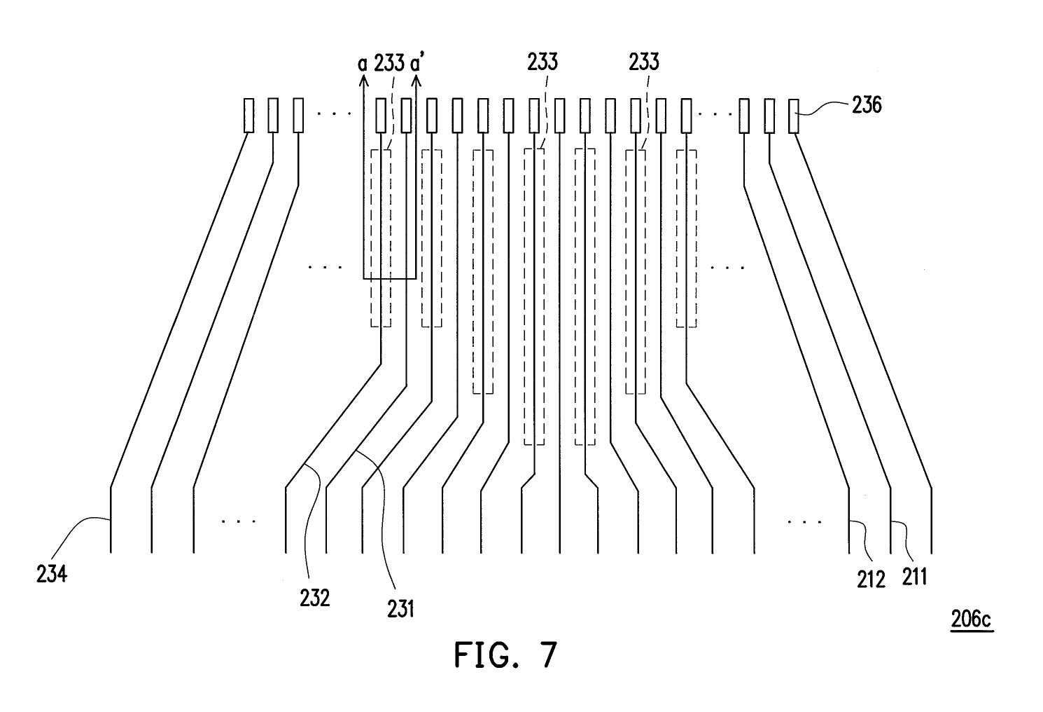

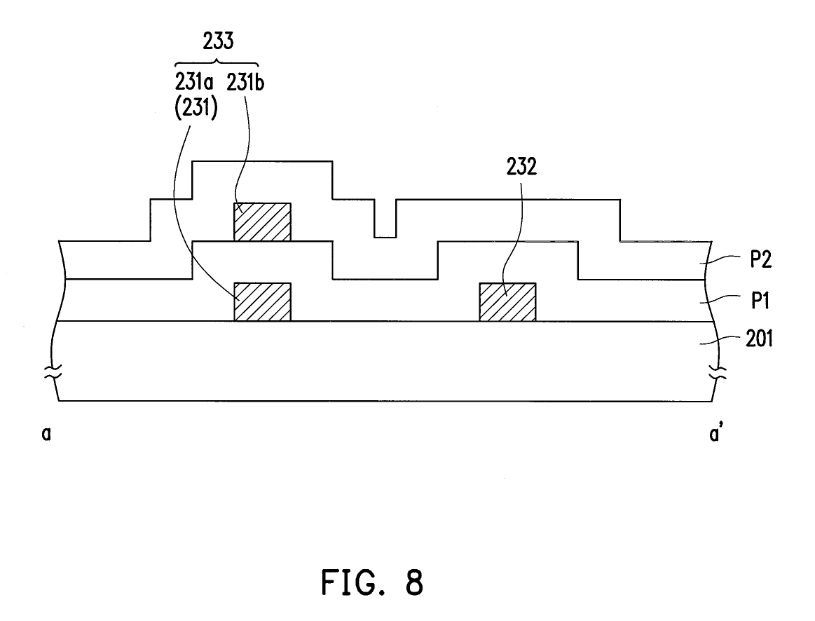

FIG. 7 is a schematic diagram of another fan-out area of the invention. FIG. 8 is a cross-sectional diagram of FIG. 7 along the a-a′ line. Referring to both FIGS. 7 and 8, the circuit layout principle of the fan-out area 206c includes, for example, using a multi-layer wiring to adjust the impedance. Wherever possible, the same reference numbers used in the fan-out area 206c and the above-mentioned fan-out area 206 are referred to the same or like parts.

In the fan-out area 206c, the impedance adjusting units 233 (the area depicted by the dotted lines) of the main transmission lines 231 include, for example, a multi-layer wiring, and this multi-layer wiring includes, for example, multi layers of conductive lines 231a, 231b stacked and electrically parallel connected together.

The first-layer conductive lines 231a are, for example, a part of the main transmission lines 231, wherein the first-layer conductive lines 231a and the sub transmission lines 232 are disposed directly on the substrate 201. A first passivation layer P1 is disposed on the substrate 201 covering the first-layer conductive lines 231a and the sub transmission lines 232. The second-layer conductive lines 231b are disposed on the first passivation layer P1, configured above the first-layer conductive lines 231a. Moreover, the second pasivation layer P2 covers the second conductive lines 231b and the first passivation layer P1.

The two ends of the second-layer conductive lines 231b are electrically connected with the first-layer conductive lines 231a through a contact via (not shown). Accordingly, the effect of low impedance of the main transmission lines 231 is achieved in fan-out area 206c by the electrically parallel connection of multi-layer conductive lines. It should be appreciated that the stacked number of the conductive lines can be even more; in other words, the purpose of impedance adjustment is accomplishable by applying three layers or even more layers of conductive lines and electrically parallel connecting the various layers of the conductive lines.

In accordance to the above disclosure, the active device array substrate 200 of the invention employs different circuit layouts in the fan-out areas 206, 206a, 206b, 206c for adjusting impedances of the main transmission lines 231. Since the sub transmission lines 232 do not require any impedance adjustment, the fan-out areas 206, 206a, 206b, 206c can afford a larger space for disposing the impedance adjusting units 233 of the main transmission lines 231. Based on these exemplary designs on impedance adjustment, the main transmission lines 231 of the active device array substrate 200 comprise a more uniform transmission impedance and transmission quality. It is worthy to note that, the different ways of the circuit layout in the fan-out areas 206, 206a, 206b, 206c may be applied in a same fan-out area. The invention is not limited to applying one method for performing the impedance adjustment of the main transmission line in the same fan-out area.

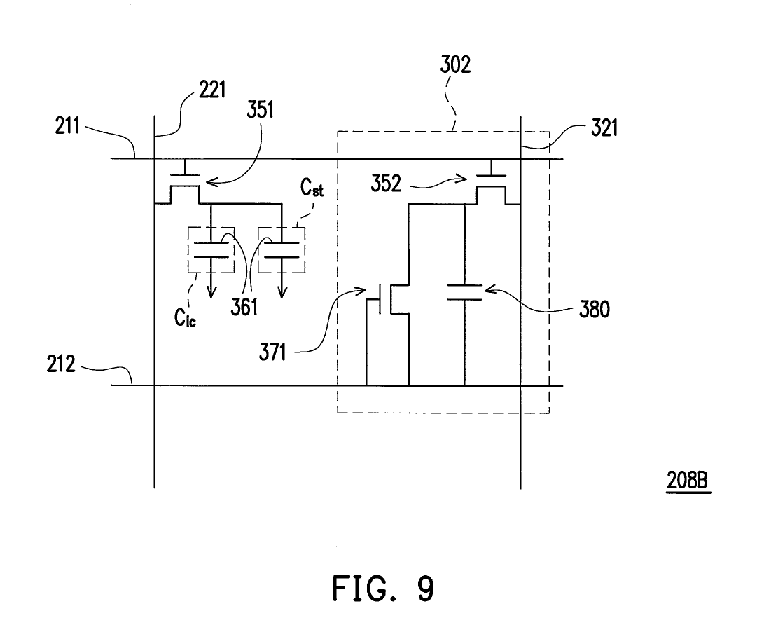

FIG. 9 is another circuit diagram of the pixel structure in FIG. 2. Referring to both FIGS. 2 and 9, in this exemplary embodiment, the active device array substrate 200 is, for example, one substrate of a touch sensing display panel. The pixel structure 208B includes a first active device 351, a pixel electrode 361, a touch sensing device 302 and a signal readout line 321. The touch sensing device 302 is disposed in the active region 204. The plurality of control lines 212 is electrically connected to the plurality of touch sensing devices 302 and the corresponding plurality of sub transmission lines 232. The first active device 351 is electrically connected to a scan line 211 and a data line 221. The pixel electrode 361 and the first active device 351 are electrically connected. Further, to stabilize the liquid crystal capacitor C_{1c} for maintaining a desirable display quality, the liquid crystal capacitor C_{1c} is electrically connected with the corresponding storage capacitor Cₛₜ.

The touch sensing device 302 includes a second active device 352, a control switch 371 and a touch sensing capacitor 380. The second active device 352 is electrically connected to the scan line 211, the control switch 371 and the read-out line 321. The control switch 371 is electrically connected to the control line 212. It is known to a person of ordinary skill practicing this invention on the connection principle and the operational theory of each component in the touch sensing panel, and the details thereof will not be further reiterated herein.

Generally speaking, the voltage transmitted by the control line 212 controls the turning on or off of the touch sensing device 302. When the touch sensing device 302 is turned on, changes in the touch sensing capacitor 380 is read through the read-out lines 321 to identify the position of the touched position. It should be noted that the examples above are not intended to restrict the scope of this invention, and the active device array, substrate described above may include other designs of the touch sensing circuit.

Since the charging time of the control switch 371 does not affect the sensing function of the touch sensing device 302, the operational efficiency of the active device array substrate 200 is not affected by the signal transmission quality of the control lines 212. However, the display quality of the pixel structure 208B is affected by the signal transmission quality of the scan lines 211. Hence, the approaches of circuit design of the fan-out areas 206, 206a, 206b, 206c in accordance to the exemplary embodiments of the invention above may be applied to adjust the impedance of the main signal transmission lines that are connected to the scan lines 211. Ultimately, desirable display quality is achieved by the active device array substrate 200 of the exemplary embodiments of the invention.

It is worthy to note that, according to the circuit design in the exemplary embodiments, a sub transmission line 232 is disposed next every main transmission line 231; in other words, a touch sensing device 302 is disposed in the pixel structure 208 on each scan line 211. In other exemplary embodiments, the circuit design of the active device array substrate 200 may include the disposition of the touch sensing device 302 in the pixel structure 208 on certain scan lines 211. In other words, the design of the fan-out area may include disposing “m” sub transmission lines next every “n” main transmission line, wherein n and m are positive integers. In other exemplary embodiments, the design of the touch sensing device 302 may be integrated in the pixel structure 208 as illustrate in FIG. 3. Accordingly, two control lines 212 are disposed between two scan lines 211; in other words, two sub transmission lines 232 are disposed between two main transmission lines 231.

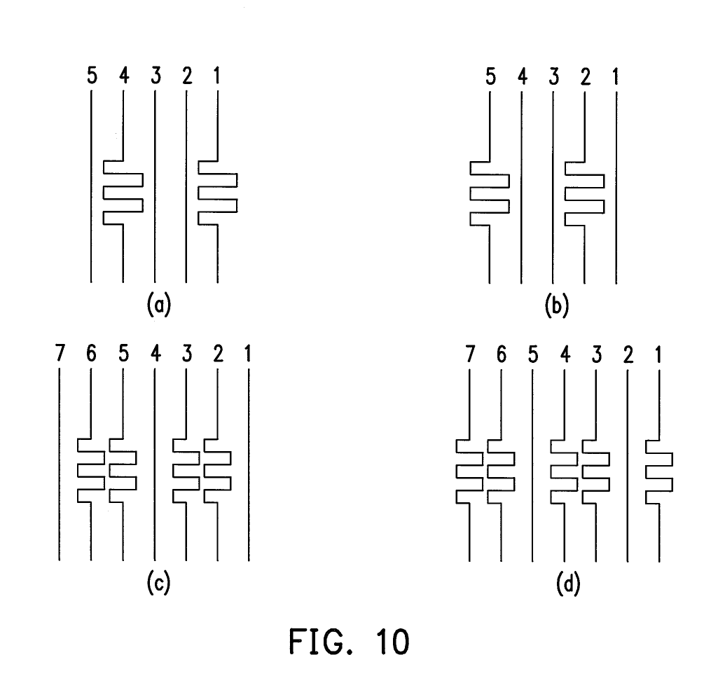

From the active device array substrate 200 of FIG. 2, the number and the allocation relationship of the main transmission lines 231 and the sub transmission lines 232 can be altered according to the different circuit designs and the different pattern arrangements of the pixel structure 208. For example, in FIG. 10(a), the 1^{st}, 4^{th}, . . . conductive lines are the main transmission lines while the remaining conductive lines are the sub transmission lines. Alternatively speaking, the 1^{st},4^{th}, . . . conductive lines are under impedance adjustment. In FIG. 10(b), the 2^{nd}, 5^{th}, . . . conductive lines are the main transmission lines, while the remaining conductive lines are the sub transmission lines. In other words, 2^{nd}, 5^{th}, . . . conductive lines are under impedance adjustment. In summary, two sub transmission lines are disposed next every main transmission line according to the exemplary embodiments shown in FIGS. 10(a) and 10(b).

Further, in FIG. 10(c), the 2^{nd}, 3^{rd}, 5^{th}, 6^{th} conductive lines are the main transmission lines, while the remaining conductive lines are sub transmission lines. In other words, the 1^{st}, 4^{th}, 7^{th}, . . . conductive lines are not under impedance adjustment. In FIG. 10(d), the 1^{st}, 3^{rd}, 4^{th}, 6^{th}, 7^{th}, 9^{th}, 10^{th} . . . conductive lines are the main transmission lines, while the remaining conductive lines are sub transmission lines. In other words, the 2^{nd}, 5^{th} . . . conductive lines are not under impedance adjustment. Simply speaking, one sub transmission line is disposed next every two main transmission lines according to the exemplary embodiments shown in FIGS. 10(c) and 10(d).

It should be noted that the examples of above circuit designs are not intended to restrict the scope of this invention. The allocation of the main transmission lines 231 and the sub transmission lines 232 depends on the application and the circuit design of the active device array substrate 200.

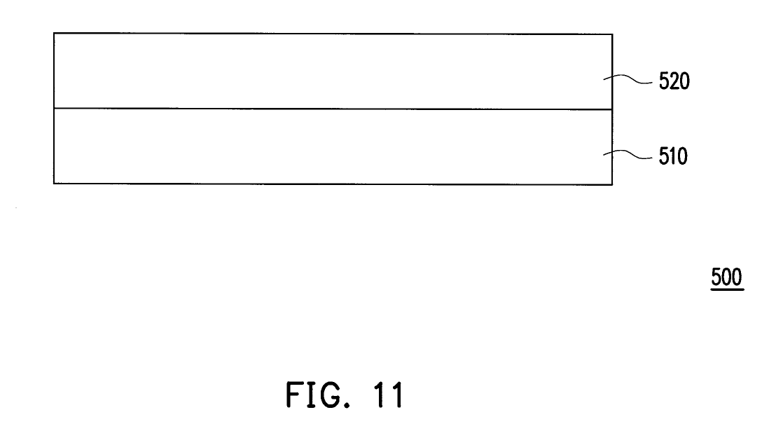

FIG. 11 is a schematic diagram of a display device according to an exemplary embodiment of the invention. Referring to FIG. 11, the display device 500 includes a first substrate 510 and a second substrate 520. The first substrate 510 may be the active device array substrate disclosed in the above exemplary embodiments.

The second substrate 520 is disposed opposite to the first substrate 510, wherein the second substrate 520 is, for example, a color filter substrate or other possible substrates. In some aspects of the invention, a display medium layer (not shown) may be disposed between the first substrate 510 and the second substrate 520. The display device 500 could be a touch sensing display panel, a liquid crystal display panel, a flexible display panel, an organic light emitting display or an electrophoresis display panel, etc. depending on the material type of the display medium layer.

Since the display device 500 includes the above-mentioned active device array substrates 200, 300, each pixel structure has a sufficient charging time and the charging voltage level is uniform. Thus, the display device 500 has a desirable display quality.

In accordance to the above exemplary embodiments, the active device array substrate of the invention applies different designs of the impedance adjusting unit to adjust the impedance of the main transmission lines, while the impedance of the sub transmission lines are not be adjusted. Thus, the main transmission lines are provided with a larger space for impedance adjustment, and the design on impedance adjustment of the conductive lines of the active device array substrate is more attuned to the actual demands. Moreover, since the display device of the invention includes the above active device array substrate, each pixel structure has a sufficient charging time and the charging voltage level is uniform. In other words, the display device of the invention is provided with a desirable display quality.

Although the disclosure herein refers to certain illustrated embodiments, it is to be understood that these embodiments are presented by way of example and not by way of limitation. The intent of the detailed description is to cover all modifications, alternatives, and equivalents as may fall within the spirit and scope of the invention as defined by the appended claims. Moreover, any embodiment of the invention or claims to achieve all the features, advantages or characteristics disclosed in the invention. Additionally, the abstract and the title of the invention are intended to facilitate patent search and not intended to be restrictive of the spirit and scope of the invention.

What is claimed is:

1. An active device array substrate comprising:
a substrate, comprising an active region and a peripheral region, wherein the peripheral region is positioned at a periphery of the active region;
a plurality of scan lines, disposed in the active region of the substrate;
a plurality of control lines, disposed in the active region of the substrate, parallel to the plurality of scan lines, wherein “m” control lines are disposed next every “n” scan lines, and “n” and “m” are positive integers;
a plurality of data lines, intersecting with the plurality of scan lines and the plurality of the control lines;
a plurality of pixel structures, disposed in the active region of the substrate, wherein a display voltage transmitted by the plurality of data lines is controlled by a scan voltage of the plurality of scan lines and is inputted to the plurality of pixel structures;
a plurality of main transmission lines, positioned in the peripheral region of the substrate and connected with the plurality of scan lines;
a plurality of sub transmission lines, positioned in the peripheral region of the substrate and connected with the plurality of control lines, wherein the plurality of sub transmission lines and the plurality of main transmission lines are configured alternately,
wherein each of the plurality of main transmission lines comprises at least an impedance adjusting unit, and an impedance difference between at least one of the plurality of main transmission lines and one of adjacent sub transmission lines is greater than 3 ohms (Ω).

2. The active device array substrate of claim 1, wherein each pixel structure of the plurality pixel structures comprises:
a first active device, electrically connected with one of the plurality of scan lines and one of the plurality of data lines;
a second active device, electrically connected with one of the plurality of scan lines and one of the plurality of data lines;
a first pixel electrode, electrically connected with the first active device;
a second pixel electrode, electrically connected with the second active device;
a control switch, electrically connected with the second pixel electrode, and one of the plurality of control lines is electrically connected with the control switch.

3. The active device array substrate of claim 1 further comprising a plurality of signal pads, configured in the peripheral region of the substrate, and the plurality of main transmission lines connects between the plurality of scan lines and the corresponding plurality of signal pads, and the plurality of sub transmission lines connects between the plurality of control lines and the corresponding plurality of signal pads.

4. The active device array substrate of claim 1, wherein “m” sub transmission lines are disposed next every “n” main transmission lines.

5. The active device array substrate of claim 1 further comprising a plurality of touch sensing devices disposed in the active region, and the plurality of control lines is electrically connected with the plurality the touch sensing devices and the corresponding plurality of sub transmission lines.

6. The active device array substrate of claim 1, wherein the at least impedance adjusting unit comprises at least a circuitous line.

7. The active device array substrate of claim 6, wherein the at least circuitous line comprises a plurality of first line segments and a plurality of second line segments, and the plurality of first line segments extends along a first extension direction, and the plurality of second line segments extends along a second extension direction, and the plurality of first line segments and the plurality of second line segments are connected end-to-end.

8. The active device array substrate of claim 7, wherein lengths of the plurality of first line segments are different from lengths of the plurality of the second line segments.

9. The active device array substrate of claim 7, wherein the first direction is parallel to an extension direction of the plurality of main transmission lines, and the second direction is perpendicular to the extension direction of the plurality of main transmission lines.

10. The active device array substrate of claim 1, wherein the at least impedance adjusting unit comprises a multi-layer wiring, and the multi-layer wiring comprises multi layers of conductive lines that are stacked and connected in parallel.

11. The active device array substrate of claim 1, wherein a line width of the at least impedance adjusting unit of one main transmission line of the plurality of main transmission lines is different form a line width of the at least impedance adjusting unit of another main transmission line of the plurality of main transmission lines.

12. The active device array substrate of claim 11, wherein line widths of the plurality of sub transmission lines are constant values.

13. The active device array substrate of claim 11, wherein line widths of the main transmission lines range from 5 μm to 40 μm.

14. The display device, comprising:
a first substrate, wherein the first substrate is the active device array substrate as claimed in claim 1; and
a second substrate, disposed opposite to the first substrate.

15. The display device of claim 14, wherein the display device is a touch sensing display panel, a liquid crystal display panel, a flexible display panel, an organic light emitting display or an electrophoresis display panel.
